(19) United States
(12) Patent Application Publication
(10) Pub. No.: US 2022/0248731 A1
(43) Pub. Date: Aug. 11, 2022

(54) FRUIT PREPS AND OTHER SWEET SAUCES COMPRISING SUGAR REDUCTION SOLUTIONS AND STARCH

(71) Applicant: CORN PRODUCTS DEVELOPMENT, INC., Westchester, IL (US)

(72) Inventor: Didem ICOZ, Bridgewater, NJ (US)

(21) Appl. No.: 17/623,572

(22) PCT Filed: Jun. 24, 2020
(86) PCT No.: PCT/US2020/039377

§ 371 Date: Dec. 28, 2021

Related U.S. Application Data
(60) Provisional application No. 62/868,817, filed on Jun. 28, 2019.

(51) Int. Cl. A23L 27/30; A23L 29/212; A23L 29/30; A23L 19/00; A23L 23/00; A23L 21/10; A23L 27/60; A23C 9/13

(52) U.S. Cl. CPC A23L 27/33; A23L 29/212; A23L 29/30; A23L 19/00; A23V 2002/00; A23L 21/10; A23L 27/60; A23C 9/1307; A23L 23/00

(57) ABSTRACT

Described herein are food product compositions comprising a sugar reduction solution comprising a rare sugar, xylo-oligosaccharide, or a combination thereof as a partial or complete replacement for a nutritive sweetener. Various food products containing compositions described herein and methods of making the same are also described. Beneficially, compositions comprising the sugar reduction solution described herein are more stable compositions that do not exhibit syneresis and/or enable the starch content contained therein to be reduced in comparison to full-sugar starch-containing products.

### CROSS-REFERENCE TO RELATED APPLICATION

This application claims priority under 35 U.S.C. § 119 to Provisional application U.S. Ser. No. 62/868,817, filed on Jun. 28, 2019, which is hereby incorporated herein by reference in its entirety.

Described herein are fruit preparations, sweet sauces, and other food product compositions comprising a sugar reduction solution comprising a rare sugar, xylo-oligosaccharide, or a combination thereof as a partial or complete replacement of a nutritive sweetener. Various food products containing the fruit preparations, sweet sauces, and other food products compositions and methods of making the same are also described herein. The fruit preparations, sweet sauces, and other food product compositions described herein beneficially reduce added sugars and caloric content while overcoming formulation limitations of low- or reduced-sugar products, including building back the bulk, texture, taste and other functional properties of sugar. Beneficially, the compositions comprising a sugar reduction solution described herein are more stable compositions that do not exhibit syneresis and/or enable the starch content contained therein to be reduced in comparison to full-sugar products that contain starch.

Sweeteners are commonly included in food products. Nutritive sweeteners include sucrose, glucose, fructose, corn syrup (including high fructose corn syrup), maltose, lactose, molasses, honey, agave and others, and contribute to caloric content. The term nutritive sweetener and sugar are used interchangeably herein. Natural and synthetic sweeteners (i.e. artificial sweeteners) are alternatives to nutritive sweeteners as they provide desirable taste characteristics as well as other functional properties with a significantly lower caloric content. Such alternative sweeteners include, e.g., high potency or high intensity sweeteners (e.g. Splenda); sugar alcohols or polyols (e.g. xylitol, sorbitol, etc.); stevia sweeteners; rare sugars; and polymers of the sugar xylose (e.g., xylo-oligosaccharides (“XOS”). Allulose and tagatose are examples of rare sugars because they are found in nature in very small amounts. Allulose is also referred to as D-allulose, psicose, or D-psicose, and is a non-nutritive sweetener found naturally in certain foods, such as raisins and figs. Allulose provides approximately 70% of the sweetness of sucrose with only 10% of the calories (approximately 0.4 kcal/g).

There is an ongoing initiative to reduce consumer intake of nutritive sweeteners to provide both caloric reduction and total/added sugar reduction, increasing the use of alternative sweeteners in food products. As a result, Alternative sweeteners have been formulated into various food products in an attempt to provide, for example, food products exhibiting the desired bulking, sweetening and functional properties traditionally provided by nutritive sweeteners. See, e.g., WO2015/075473. However, the formulations in which the nutritive sweetener has been replaced by an alternative sweetener are often not adjusted to accommodate the properties of the alternative sweetener, which behaves differently in the formulation than the nutritive sweetener. As a result, such formulations do not provide reduced-sugar food products exhibiting the properties that consumers and food manufacturers expect of the reformulated food product. Accordingly, there remains a need in the food industry for reduced-sugar food products that perform the same as or better than their full-sugar counterparts. Unexpectedly and surprisingly, one or more sugar reduction solutions described herein performs as well as or better than full sugar controls in one or more fruit preparation, sweet sauce, and/or other food product compositions described herein, providing benefits beyond sugar and calorie reduction.

Disclosed herein are fruit preparations, sweet sauces, and other food product compositions comprising one or more sugar reduction solution comprising a rare sugar, xylo-oligosaccharide, or a combination thereof that beneficially reduces sugar and calorie content while providing functional build back properties similar to sugar thereby providing the consumer with a product having an expected look, smell and feel while unexpectedly and surprisingly exhibiting superior stability compared to a full sugar counterpart.

In one embodiment, a food product composition comprises a sugar reduction solution comprising a rare sugar, xylo-oligosaccharide, or a combination thereof; starch; and water; wherein the sugar reduction solution is a partial or complete replacement of a nutritive sweetener; wherein the composition is stable and does not exhibit syneresis at refrigerated storage over at least 2 weeks as measured by an increase in Hunter L scale measurement of color less than about 5%; and wherein the composition has a reduction of one or more of sugar, calorie and starch in comparison to a full-sugar food product composition that does not have the nutritive sweetener replaced by a sugar reduction solution.

In another embodiment, a food product composition comprises: allulose; starch; and water; wherein the allulose is a partial or complete replacement of a nutritive sweetener; wherein the food product is stable and does not exhibit syneresis at refrigerated storage over at least 2 weeks as measured by an increase in Hunter L scale measurement of color less than about 5%; and wherein the food product has a sugar, calorie and/or starch reduction in comparison to a full sugar food product not having nutritive sweetener replaced by allulose.

Another embodiment is directed to using a sugar reduction solution to reduce syneresis in a food product composition comprising: replacing at least a portion of a nutritive sweetener in a food product composition with a sugar reduction solution comprising a rare sugar, xylo-oligosaccharide, or a combination thereof; and forming a stable food product composition that does not exhibit syneresis under refrigerated storage conditions over at least 2 weeks as measured by an increase in Hunter L scale measurement of color less than about 5%.

Yet another embodiment is directed to using an allulose-containing food product composition to reduce syneresis in a composition comprising: replacing at least a portion of a nutritive sweetener in a food product composition with allulose; and forming a stable food product composition that does not exhibit syneresis under refrigerated storage conditions over at least 2 weeks as measured by an increase in Hunter L scale measurement of color less than about 5%.

Still another embodiment is directed to using a sugar reduction solution to reduce starch content in a composition comprising: replacing at least a portion of a nutritive sweetener in a food product composition with a sugar reduction solution comprising a rare sugar, xylo-oligosaccharide, or a combination thereof; and forming a stable composition that does not exhibit syneresis and maintains a higher and/or stable viscosity thereby providing the opportunity for reducing the wt-% starch required in the composition.

Yet still another embodiment is directed to using an allulose-containing food product to reduce starch content in a composition comprising: replacing at least a portion of a nutritive sweetener in a food product composition with allulose; and forming a stable food product composition that does not exhibit syneresis and maintains a higher and stable viscosity thereby reducing the wt-% starch required in the composition.

Various embodiments of the present invention will be described in detail with reference to the drawings, wherein like reference numerals represent like parts throughout the several views. And while multiple embodiments are disclosed herein, still other embodiments will become apparent to those skilled in the art from the following detailed description, which shows and describes illustrative embodiments. As a result, reference to various embodiments does not limit the scope of the invention. Additionally, the figures represented herein are not limitations to the various embodiments according to the invention and are presented for exemplary illustration of the invention. Accordingly, the drawings and detailed description are to be regarded as illustrative in nature and not restrictive.

### BRIEF DESCRIPTION OF THE DRAWINGS

The patent or application file contains at least one drawing executed in color. Copies of this patent or patent application publication with color drawing(s) will be provided to the Office upon request and payment of the necessary fee.

FIGS. 1A-1D show color images of fruit preparations containing varying sugar content (with and without allulose) 24 hours after formulation as evaluated in Example 1 for syneresis.

FIGS. 2A-2D show color images of fruit preparations containing varying sugar content (with and without allulose) 2 weeks after formulation as evaluated in Example 1 for syneresis.

FIGS. 3A-3D show color images of fruit preparations containing varying sugar content (with and without allulose) 5 weeks after formulation as evaluated in Example 1 for syneresis.

FIGS. 4A-4D show color images of fruit preparations containing varying sugar content (with and without allulose) 12 weeks after formulation as evaluated in Example 1 for syneresis.

FIG. 5 shows quantifiable color measurements of fruit preparations containing varying sugar content (with and without allulose) over time as evaluated in Example 1 for syneresis.

FIG. 6 shows viscosity measurements of fruit preparations stored at room temperature containing varying sugar content (with and without allulose) over time as evaluated in Example 2.

FIG. 7 shows water activity measurements of fruit preparations stored at room temperature containing varying sugar content (with and without allulose) over time as evaluated in Example 2.

FIG. 8 shows color images of fruit preparations containing varying cooking methods during formulation as outlined in Example 4.

FIGS. 9A-9B show color images of fruit preparations containing varying starches (with and without allulose) 24 hours, 2 weeks, 5 weeks and 12 weeks after formulation as evaluated in Example 4 for syneresis.

FIG. 10 shows color images of fruit preparations containing varying sweeteners and fibers in comparison to allulose 24 hours, 2 weeks, 5 weeks and 12 weeks after formulation as evaluated in Example 6 for syneresis.

All terminology used herein is for the purpose of describing particular embodiments only, and is not intended to be limiting in any manner or scope. For example, as used in this specification and the appended claims, the singular forms “a,” “an” and “the” can include plurals unless the context clearly indicates otherwise. Further, all units, prefixes, and symbols may be denoted in its SI accepted form. Numeric ranges recited within the specification are inclusive of the numbers within the defined range. Throughout this disclosure, various aspects are presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range (e.g. 1 to 5 includes 1, 1.5, 2, 2.75, 3, 3.80, 4, and 5).

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments without undue experimentation. In describing and claiming the embodiments, the following terminology will be used in accordance with the definitions set out below.

The term “about,” as used herein, refers to variations in the numerical quantity that can occur, for example, through typical measuring and handling procedures; through inadvertent error in these procedures; through differences in the manufacture, source, or purity of the ingredients; and the like. Whether or not modified by the term “about”, the claims include equivalents to the quantities.

As used herein, the term “free” refers to compositions completely lacking the component or having such a small amount of the component that the component does not affect the performance of the composition. The component may be present as an impurity or as a contaminant and shall be less than 0.5 wt-%.

The term “syneresis,” as used herein refers to formation of a gel accompanied by the separation out of the water and quantified by a Hunter L scale measurement of color increase greater than at least 5%, at least 4.5%, at least 4%, or at least 3.5% after refrigerated storage over at least 24 hours, at least 72 hours, at least 1 week, or at least 2 weeks. As described herein, replacement of partial or complete sugar content with allulose eliminates syneresis and provides a stable food product.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

The methods and compositions may comprise, consist essentially of, or consist of the components and ingredients as well as other ingredients described herein. As used herein, “consisting essentially of” means that the methods and compositions may include additional steps, components or ingredients, but only if the additional steps, components or ingredients do not materially alter the basic and novel characteristics of the claimed methods and compositions.

Food Product Compositions

The food product compositions described herein include a sugar reduction solution comprising a rare sugar, xylo-oligosaccharide, or a combination thereof as a complete or partial replacement for nutritive sweeteners, including sucrose. In some embodiments, the food product compositions described herein include allulose as a complete or partial replacement for nutritive sweeteners, including sucrose. In further embodiments, the food product compositions comprise a sugar reduction solution comprising a rare sugar, xylo-oligosaccharide, or a combination thereof; starch; and water. In still other embodiments, the food product compositions comprise allulose; starch; and water. In other embodiments, the food product compositions may further comprise remaining nutritive sweeteners not fully replaced by allulose (i.e. products that are not 100% sugar reduced), stabilizing agents, flavorings and/or extracts, and/or other additional ingredients. Exemplary food product compositions are shown in Table 1.

TABLE 1
Exemplary Food Product Compositions

| | First | Second | Third |
|---|---|---|---|
| | Exemplary | Exemplary | Exemplary |
| Material | Range wt-% | Range wt-% | Range wt-% |
| Rare Sugar or Xylo- | 5-90 | 10-90 | 20-90 |
| oligosaccharide | | | |
| Starch | 0.1-10 | 0.5-10 | 1-5 |
| Water | 5-60 | 10-60 | 10-50 |
| Additional Functional | 0-40 | 0-30 | 0-20 |
| Ingredients | | | |

In some embodiments, the allulose or the sugar reduction solution comprising a rare sugar, xylo-oligosaccharide, or a combination thereof replaces or substantially reduces the use of nutritive sweeteners in the food product compositions (e.g. fruit prep or sweet sauces), such that the nutritive sweetener contained therein is reduced by at least about 10%, 20%, 30%, 40%, 50%, 55%, 60%, 65%, 70%, 75%, 80%, 85%, 90%, 95%, or 100%. Exemplary nutritive sweeteners include, but are not limited to, sucrose, glucose, fructose, high fructose corn syrup, dextrose, various DE corn syrups, beet or cane sugar, molasses, maltose, honey, and maple sugar.

Beneficially, the replacement of nutritive sweeteners with allulose or a sugar reduction solution comprising a rare sugar, xylo-oligosaccharide, or a combination thereof provides a stable food product composition, wherein the product does not exhibit syneresis. In an embodiment, the food products containing allulose or a sugar reduction solution comprising a rare sugar, xylo-oligosaccharide, or a combination thereof when subjected to refrigerated storage (approximately 4° C.) over at least 72 hours (or longer) have a measured increase in Hunter L scale measurement of color less than about 5%, less than about 4.5%, less than about 4%, or less than about 3.5%. In another embodiment, the food products containing allulose or a sugar reduction solution comprising a rare sugar, xylo-oligosaccharide, or a combination thereof when subjected to refrigerated storage (approximately 4° C.) over at least 72 hours (or longer) have a measured increase in Hunter L scale measurement of color less than about 3.5%.

In additional embodiments, the food product compositions containing allulose or a sugar reduction solution comprising a rare sugar, xylo-oligosaccharide, or a combination thereof beneficially provide at least a 25% reduction in sugar by replacing at least a portion of a nutritive sweetener with the allulose or sugar reduction solution. In additional embodiments, the allulose or sugar reduction solution comprising a rare sugar, xylo-oligosaccharide, or a combination thereof provides at least a 30%, 35%, 40%, 45%, 50%, 55%, 60%, 65%, 70%, 75%, 80%, 85%, 90%, 95%, or 100% reduction in sugar.

In still further embodiments, food product compositions containing allulose or a sugar reduction solution comprising a rare sugar, xylo-oligosaccharide, or a combination thereof beneficially provide at least a 50% reduction in caloric content by replacing at least a portion of nutritive sweeteners with the allulose or sugar reduction solution. In additional embodiments, the replacement of nutritive sweeteners with the allulose or sugar reduction solution comprising a rare sugar, xylo-oligosaccharide, or a combination thereof provides at least a 20%, 25%, 30%, 35%, 40%, 45%, 50%, 55%, 60%, 65%, 70%, 75%, 80%, 85%, 90%, 95%, or 100% reduction in calories.

In still further embodiments, food product compositions containing allulose or a sugar reduction solution comprising a rare sugar, xylo-oligosaccharide, or a combination thereof beneficially provide at least a 1%, 2%, 3%, 4%, 5%, 6%, 7%, 8%, 9%, 10%, 11%, 12%, 13%, 14%, 15%, 16%, 17%, 18%, 19%, or 20% reduction in starch in comparison to a full-sugar food product not having the nutritive sweetener replaced by allulose or a sugar reduction solution. Beneficially, the reduction in starch is not limited by the type of starch in the food production composition. The use of allulose or a sugar reduction solution comprising a rare sugar, xylo-oligosaccharide, or a combination thereof in a food product composition is suitable for reduction of various types of starches, including granular starches or modified starches.

Rare Sugars

The food product compositions, including fruit prep compositions and sweet sauces, describe herein can include a rare sugar. Exemplary rare sugars include, but are not limited to, allulose, tagatose, sorbose (L-sorbose), allose, and apoise. These are exemplary ‘rare sugars’ as they are found in nature in very small amounts. For example, allulose provides approximately 70% of the sweetness of sucrose with only 5% of the calories (approximately 0.2 kcal/g) and is often considered to be a ‘zero calorie’ sweetener.

D-Tagatose

The food product compositions, including fruit prep compositions and sweet sauces, described herein can include tagatose (also known as D-tagatose) as the rare sugar. Tagatose is a low-calorie monosaccharide, prebiotic, low-glycemic rare sugar. D-tagatose is a commercially-available monosaccharide having the following structure,

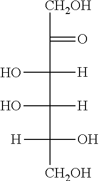 [SMILES: O=C(CO)C(O)C(O)C(O)CO]

In a further embodiment, the D-tagatose comprises from about 5 wt-% to about 90 wt-% of the food product composition, from about 10 wt-% to about 90 wt-% of the food product composition, from about 20 wt-% to about 90 wt-% of the food product composition, or from about 25 wt-% to about 90 wt-% of the food product composition.

Allulose

The food product compositions, including fruit prep compositions and sweet sauces, can include allulose as the rare sugar. Allulose is a commercially-available monosaccharide having the following structure, which is a C3 epimer of D-fructose:

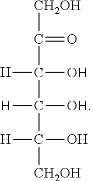 [SMILES: O=C(CO)C(O)C(O)C(O)CO]

Allulose is available in crystalline form or in the form of a syrup comprising allulose. The syrup forms comprise allulose in varying amounts of percent solids (generally between about 60% to about 90% by weight).

An exemplary allulose source is available under the tradename ASTRAEA® Liquid Allulose, with 95% purity (dry solids basis, ds or DS) and at 74% solids. Additional allulose sources may have a purity (expressed as weight % allulose, based on the total weight of the allulose source) of at least 80%, at least 85%, at least 90%, at least 95%, at least 96%, at least 97%, at least 98%, at least 99%, or at least 99.9%, or 100% pure allulose. Additional allulose sources may have a percent purity of at least about 65%, at least about 70%, at least about 75%, or greater.

In some embodiments, the allulose source is a mixture of allulose and additional monosaccharides and disaccharides, determined according to the purity level of the allulose. In some embodiments, the allulose source may be an admixture of allulose and one or more other sugars, such as fructose. In some embodiments the allulose source is a syrup comprising from about 85 wt-% to about 95 wt-% allulose and from about 5 wt-% to about 15 wt-% of monosaccharides and disaccharides, based on the dry matter content of the syrup.

The allulose is suitable for use as a single ingredient replacement for a nutritive sweetener (e.g. sucrose), either partial or complete replacement, in the food product composition. In some embodiments, allulose is a complete replacement for a nutritive sweetener such that no nutritive sweetener remains in the food product composition to provide the beneficial reduction in sugar content, reduction in calories, reduction of starch content, and stability benefit of no syneresis of the food product composition.

In a further embodiment, the allulose comprises from about 5 wt-% to about 90 wt-% of the food product composition, from about 10 wt-% to about 90 wt-% of the food product composition, from about 20 wt-% to about 90 wt-% of the food product composition, or from about 25 wt-% to about 90 wt-% of the food product composition.

Xylo-Oligosaccharides

The food product compositions, including fruit prep compositions and sweet sauces, can include a xylo-oligosaccharide. Xylo-oligosaccharides include xylotriose, xylobiose and the like. They are polymers of the sugar xylose and have the following structure:

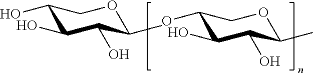

where n is a variable number of xylose units.

In a further embodiment, the xylo-oligosaccharide comprises from about 5 wt-% to about 90 wt-% of the food product composition, from about 10 wt-% to about 90 wt-% of the food product composition, from about 20 wt-% to about 90 wt-% of the food product composition, or from about 25 wt-% to about 90 wt-% of the food product composition.

Starches

The food product compositions, including fruit prep compositions and sweet sauces, can include a starch. Use of “starch” in this specification means amylose, amylopectin and mixtures thereof whether in granular, pregelatinized, or dispersed form, but that is freed from any of the one or more plant organs containing starch, for example including but not limited to tubers, seeds, and fruit. Starch useful in the methods and compositions disclosed in this specification may be obtained from a plant organ by commonly used methods in the industry, including, but not limited to wet milling, dry milling, recovery from washing or other processing of a plant organ and mixtures thereof. Starch may include impurities such as protein, fiber etc., although food grade starches commonly have greater than 98% starch by weight or greater than 99% starch by weight.

In any embodiment, a starch useful for the food product compositions described herein are obtained from any suitable starch source including but not limited to corn, tapioca, potato, sweet potato, sago palm, legumes (such as peas, lentils, chick peas, and fava beans), rice, wheat, oat, rye, barley, sago, amaranth, arrowroot, sorghum, and/or banana, and includes high amylose and low amylose variants of the foregoing, and mixtures thereof. The starch may also be waxy or non-waxy.

Use of “granular starch” means starch that has not been otherwise physically, enzymatically or chemically modified. Granular starches may also be referred to as native starches. In an embodiment, a granular starch is included in the food product composition containing allulose. Granular starches include those starches that have not been chemically modified, by mixing the starch with a chemical compound with the intention to attach chemical groups to molecules in the starch, or to crosslink such molecules, or similar chemical modifications which create new covalent bonds. In addition, granular starches include those that have not been enzymatically modified, meaning treated with enzyme in order to modify the chemical composition of the starch. As referred to herein, granular starches may mean those that have been heated, with or without water.

In another embodiment, a modified starch is included in the food product composition containing the rare sugar or xylo-oligosaccharide. Use of “modified starch” means starch that has been subjected to one or more physical, chemical, or enzymatic reactions. Illustrative but non-limiting chemical reactions include reactions to form ethers or esters, including but not limited to hydroxypropyl ethers, acetates, adipates, phosphates, succinates, e.g., octenyl succinate, tertiary and quaternary amine ethers. Starch may also be chemically crosslinked for example using epichlorohydrin, linear dicarboxylic acid anhydrides, citric acid acrolein, phosphorus oxychloride, adipic/acetic mixed acid anhydrides, and trimetaphosphate salts for food systems. Starches may also be converted to obtain starch derivatives having generally shorter degrees of polymerization than unmodified starch (such derivatized starch may characterized as a fluidity starch, or a thin-boiling starch, or a gelling starch). Converted starch may be made using for example acid hydrolysis, oxidation, enzyme conversion, heat and shear. Starch also may be modified using physical processes such as by thermal inhibition (as described in WO 95/04082 (published Feb. 9, 1995)), heat-moisture treatment, annealing, and pregelatinization. An exemplary physically modified starch is a physically modified waxy corn starch, such as those sold as NOVATION PRIMA® 300 starch and NOVATION ENDURA® 0100 starch (Ingredion Inc, Westchester, Ill.).

Beneficially, various granular and modified starches can be included in the food product compositions, as the allulose or sugar reduction solution comprising a rare sugar, xylo-oligosaccharide, or a combination thereof that replaces at least a portion of the nutritive sweetener (e.g. sucrose), provides at least comparable or improved stability as measured by syneresis in the product using various types of starches. Without being limited to a particular mechanism of action, the allulose (in comparison to sucrose), for example, competes less with the starch for water and thereby the starch cooks more fully (i.e., higher degree of starch gelatinization) and can increase viscosity of the composition.

In a further embodiment, the starch comprises from about 0.1 wt-% to about 10 wt-% of the food product composition, from about 0.5 wt-% to about 10 wt-% of the food product composition, from about 1 wt-% to about 5 wt-% of the food product composition. In embodiments described herein, the food product composition may beneficially have a reduced starch content as a result of the allulose or sugar reduction solution comprising a rare sugar, xylo-oligosaccharide, or a combination thereof replacing sucrose or other nutritive sweeteners and providing a stabilized composition having an increased viscosity compared to the full sugar food composition before replacement with the allulose or sugar reduction solution. Without being limited to a particular mechanism of action, the inclusion of the allulose or sugar reduction solution comprising a rare sugar, xylo-oligosaccharide, or a combination thereof in the food product composition produces a higher viscosity, thereby reducing the amount of starch that needs to be added to the composition.

Water

The food product compositions described herein contain water. In an embodiment, water comprises from about 5 wt-% to about 60 wt-% of the food product composition, from about 10 wt-% to about 60 wt-% of the food product composition, from about 10 wt-% to about 50 wt-% of the food product composition, or from about 15 wt-% to about 50 wt-% of the food product composition.

Additional Ingredients

The food product compositions may optionally include additional ingredients. The presence of additional ingredients will vary based upon the type of food product composition having a portion or all of the nutritive sweetener replaced with allulose or a sugar reduction solution comprising a rare sugar, xylo-oligosaccharide, or a combination thereof.

Exemplary additional ingredients include, for example, remaining nutritive sweeteners (any portion not fully replaced by allulose or sugar reduction solution comprising a rare sugar, xylo-oligosaccharide, or a combination thereof); non-nutritive sweeteners; partially-nutritive sweeteners; flavorings, extracts (e.g. vanilla and fruit flavorings) and/or flavoring liquor; bulking agents (e.g. maltodextrin, polydextrose, xanthan gum, guar gum, glucose syrup of any kind, soluble fiber of any kind, inulin, polyol, and the like); coloring additives, preservatives, antioxidants, fruit (whole, diced, mushed, purees, concentrates, and such) and combinations thereof. In an embodiment, the optional additional ingredients, when used, collectively, do not make up more than 40%, 35%, 30%, 25%, 20%, 15%, 10%, or 5% by weight of the food product composition.

Partially-Nutritive Sweeteners and Fibers

The food product compositions may include partially-nutritive (i.e. low calorie) sweeteners and fiber as sugar replacing systems in embodiments where the allulose or sugar reduction solution comprising a rare sugar, xylo-oligosaccharide, or a combination thereof does not fully replace the nutritive sweetener, such as sucrose. Examples of partially-nutritive sweeteners include, but are not limited to, sucrose, cane sugar, fructose, glucose, glucose-fructose syrup, maple syrup, honey, molasses, erythritol, maltitol, lactitol, sorbitol, mannitol, xylitol, leucrose, trehalose, galactose, rhamnose, cyclodextrin (e.g., a-cyclodextrin, P-cyclodextrin, and y-cyclodextrin), ribulose, threose, arabinose, xylose, lyxose, allose, altrose, mannose, idose, lactose, maltose, invert sugar, isotrehalose, neotrehalose, palatinose or isomaltulose, erythrose, deoxyribose, gulose, idose, talose, erythrulose, xylulose, turanose, cellobiose, glucosamine, mannosamine, fucose, fuculose, glucuronic acid, gluconic acid, glucono-lactone, abequose, galactosamine, gentio-oligoscaccharides (gentiobiose, gentiotriose, gentiotetraose and the like), galacto-oligosaccharides, sorbose, ketotriose (dehydroxyacetone), aldotriose (glyceraldehyde), nigero-oligosaccharides, fructooligosaccharides (kestose, nystose and the like), maltotetraose, maltotriol, tetrasaccharides, mannan-oligosaccharides, malto-oligosaccharides (maltotriose, maltotetraose, maltopentaose, maltohexaose, maltoheptaose and the like), dextrine, lactulose, melibiose, rhamnose, ribose, isomerized liquid sugars such as high fructose corn/starch syrup (HFCS/HFSS) (e.g., HFCS55, HFCS42, or HFCS90), coupling sugars, soybean oligosaccharides, glucose syrup, and combinations of any of the foregoing.

Exemplary low calorie sweeteners include polyols. The term “polyol”, as used herein, refers to a molecule that contains more than one hydroxyl group. A polyol may be a diol, triol, or a tetraol which contains 2, 3, and 4 hydroxyl groups respectively. A polyol also may contain more than 4 hydroxyl groups, such as a pentaol, hexaol, heptaol, or the like, which contain 5, 6, or 7 hydroxyl groups, respectively. Additionally, a polyol also may be a sugar alcohol, polyhydric alcohol, or polyalcohol which is a reduced form of carbohydrate, wherein the carbonyl group (aldehyde or ketone, reducing sugar) has been reduced to a primary or secondary hydroxyl group. Examples of polyols include, erythritol, maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, and sugar alcohols or any other carbohydrates capable of being reduced which do not adversely affect the taste of the sweetened compositions.

Non-Nutritive Sweeteners

The food product compositions may optionally include non-nutritive sweeteners in combination with the allulose or sugar reduction solution comprising a rare sugar, xylo-oligosaccharide, or a combination thereof. Non-nutritive sweeteners (e.g. high potency sweeteners) can be included in the food product compositions to provide further beneficial reduction in sugar content and reduction in caloric content. Exemplary non-nutritive sweeteners (i.e. zero calorie sweeteners) include natural and artificial sweeteners, including high-potency sweeteners.

Exemplary natural non-nutritive sweeteners are those found in nature which may be in raw, extracted, purified, or any other form (e.g. via fermentation, bio-conversion), singularly or in combination thereof and characteristically have a sweetness potency greater than sucrose, fructose, or glucose. Non-limiting examples of natural zero calorie sweeteners include steviol glycosides, including rebaudioside A (Reb A), rebaudioside B (Reb B), rebaudioside C (Reb C), rebaudioside D (Reb D), rebaudioside D2 (Reb D2), rebaudioside D4 (Reb D4), rebaudioside E (Reb E), rebaudioside F (Reb F), rebaudioside G (Reb G), rebaudioside H (Reb H), rebaudioside I (Reb I), rebaudioside J (Reb J), rebaudioside K (Reb K), rebaudioside L (Reb L), rebaudioside M2 (Reb M2), rebaudioside M (Reb M) (also known as REB X), rebaudioside N (Reb N), rebaudioside O (Reb O), rebaudioside S (Reb S), rebaudioside T (Reb T), rebaudioside U (Reb U), rebaudioside V (Reb V), rebaudioside W (Reb W), rebaudioside Z1 (Reb Z1), rebaudioside Z2 (Reb Z2), and enzymatically glucosylated steviol glycosides; amino acids, tryptophans, steviolmonoside, steviolbioside, dulcoside A, dulcoside B, rubusoside, stevia, stevioside, mogroside, mogroside IV, mogroside V, mogroside VI, iso-mogroside V, grosmomoside, neomogroside, siamenoside, Luo Han Guo sweetener, monk fruit, siamenoside, monatin and its salts (monatin SS, RR, RS, SR), curculin, glycyrrhizic acid and its salts, thaumatin, monellin, mabinlin, brazzein, hemandulcin, phyllodulcin, glycyphyllin, phloridzin, trilobtain, baiyunoside, osladin, polypodoside A, pterocaryoside A, pterocaryoside B, mukurozioside, phlomisoside I, periandrin I, abrusoside A, and cyclocarioside I. Natural high-potency sweeteners also include modified natural high-potency sweeteners.

Additional exemplary synthetic zero calorie (i.e. high-potency) sweeteners include sucralose, potassium acesulfame (Acesulfame-potassium), aspartame, alitame, saccharin, neohesperidin dihydrochalcone, cyclamate, neotame, advantame, N—[N-[3-(3-hydroxy-4-methoxyphenyl)propyl]-L-a-aspartyl]-L-phenylalanine I-methyl ester, N—[N-[3-(3-hydroxy-4-methoxyphenyl)-3-methylbutyl]-L-a-aspartyl]-L-phenylalanine I-methyl ester, N—[N-[3-(3-methoxy-4-hydroxyphenyl)propyl]-L-a-aspartyl]-L-phenylalanine I-methyl ester, salts thereof and the like. Synthetic high-potency sweeteners also include modified synthetic high-potency sweeteners.

Food Products

The food product compositions can be further formulated into food products in need of sugar and/or caloric content reduction and elimination of syneresis. Beneficially, various food products can benefit from the use of allulose or a sugar reduction solution comprising a rare sugar, xylo-oligosaccharide, or a combination thereof to replace all or a portion of nutritive sweeteners, including sucrose. As a further benefit, the food product compositions can be readily incorporated into known processes for making foods without any additional or extensive processing steps. For example, the water, starch and allulose or sugar reduction solution comprising a rare sugar, xylo-oligosaccharide, or a combination thereof can be cooked using conventional steps to cook or functionalize a starch-containing food product.

Exemplary food products include, for example: fruit preps; sweet sauces (e.g. BBQ sauce, ketchup, chocolate sauce); confections (including jams and jellies); dressings; dairy products, including alternative dairy, yogurts (e.g. blended, fruit on the bottom, flips), and non-dairy products (e.g. yogurts); and the like. In an embodiment, the fruit prep is contained in a dairy product, such as a yogurt. As referred to herein, dairy products include any type of dairy product including cream, whole milk, reduced fat milk, skim milk, milk solids, condensed milk, or any combination thereof, specifically a combination of cream and skim milk. The dairy products generally comprise an amount of dairy protein, for example whey protein containing beta-lactoglobulin, alpha-lactalbumin, or serum albumin; and the like. In some embodiments, the dairy product may be replaced with an amount of a non-dairy component such as soy milk, soy protein, almond milk, coconut milk, or any combination thereof.

Subject matter contemplated by the present disclosure is set out in the following numbered embodiments:

1. A food product composition comprising: allulose; starch; and water; wherein the allulose is a partial or complete replacement of a nutritive sweetener; wherein the food product is stable and does not exhibit syneresis at refrigerated storage over at least 2 weeks as measured by an increase in Hunter L scale measurement of color less than about 5%; and wherein the food product has a sugar, calorie and/or starch reduction in comparison to a full sugar food product not having nutritive sweetener replaced by allulose.
2. The composition according to embodiment 1, wherein the allulose is a liquid syrup comprising at least about 85% allulose and about 15% other monosaccharides and/or disaccharides, at least about 90% allulose and about 10% other monosaccharides and/or disaccharides, or at least about 95% allulose and about 5% other monosaccharides and/or disaccharides.
3. The composition according to embodiment 1 or 2, wherein the composition has less than about 40 wt-% nutritive sweetener, less than about 35 wt-% nutritive sweetener, less than about 30 wt-% nutritive sweetener, less than about 25 wt-% nutritive sweetener, less than about 20 wt-% nutritive sweetener, less than about 15 wt-% nutritive sweetener, less than about 10 wt-% nutritive sweetener, less than about 5 wt-% nutritive sweetener, or less than about 1 wt-% nutritive sweetener.
4. The composition according to any one of embodiments 1-3, wherein the composition does not include sucrose or any nutritive sweetener.
5. The composition according to any one of embodiments 1-4, wherein the starch is a chemically or physically-modified starch from a wheat, rice, corn, oat, rye, barley, tapioca, sago, amaranth, arrowroot, sorghum, pea, lentil, banana, potato, sweet potato, and/or tapioca source.
6. The composition according to embodiment 5, wherein the modified starch is a physically modified waxy corn starch.
7. The composition according to any one of embodiments 1-6, further comprising at least one additional ingredient.
8. The composition according to any one of embodiments 1-7, wherein the nutritive sweetener comprises sucrose, glucose, glucose syrup, isoglucose, fructose, glucose-fructose syrup, maltose, lactose, corn syrup, high fructose corn syrup, molasses, honey, agave, or mixtures thereof.
9. The composition according to embodiment 8, wherein the nutritive sweetener is sucrose.
10. The composition according to any one of embodiments 1-9, wherein the food product has at least a 25% sugar reduction, at least a 50% sugar reduction, at least a 75% sugar reduction, or a 100% sugar reduction in comparison to a full sugar food product not having the nutritive sweetener replaced by allulose.
11. The composition according to any one of embodiments 1-10, wherein the food product has at least a 20% calorie reduction, at least a 30% calorie reduction, at least a 40% calorie reduction, 50% calorie reduction, at least a 60% calorie reduction, at least a 70% calorie reduction, or at least a 80% calorie reduction in comparison to a full sugar food product not having the nutritive sweetener replaced by allulose.
12. The composition according to any one of embodiments 1-11, wherein the food product has at least a 5% starch reduction in comparison to a full sugar food product not having the nutritive sweetener replaced by allulose.
13. The composition according to any one of embodiments 1-12, wherein the food product is a fruit prep, sweet sauce, confection (e.g. jams and jellies), or dressing.
14. The composition of embodiment 13, wherein the fruit prep is used in a sweetened yogurt (dairy and/or non-dairy).
15. The composition according to embodiment 13, further comprising an additional non-nutritive or partially-nutritive sweetener.
16. Use of an allulose-containing food product to reduce syneresis in a composition comprising: replacing at least a portion of a nutritive sweetener in a food product with allulose; and forming a stable food product composition that does not exhibit syneresis under refrigerated storage conditions over at least 2 weeks as measured by an increase in Hunter L scale measurement of color less than about 5%.
17. Use of an allulose-containing food product to reduce starch content in a composition comprising: replacing at least a portion of a nutritive sweetener in a food product with allulose; and forming a stable food product that does not exhibit syneresis and maintains a higher and stable viscosity thereby reducing the wt-% starch required in the composition.
18. The use according to embodiment 16 or 17, wherein the allulose is a liquid syrup comprising at least about 85% allulose and about 15% other monosaccharides and/or disaccharides, at least about 90% allulose and about 10% other monosaccharides and/or disaccharides, or at least about 95% allulose and about 5% other monosaccharides and/or disaccharides.
19. The use according to any one of embodiments 16-18, wherein the allulose replaces at least about 25%, at least about 50%, at least about 75%, or 100% of the nutritive sweetener, wherein the nutritive sweetener comprises sucrose.
20. The use according to any one of embodiments 16-19, wherein the starch is a chemically or physically modified starch from a wheat, rice, corn, oat, rye, barley, tapioca, sago, amaranth, arrowroot, sorghum, pea, lentil, banana, potato, sweet potato, or tapioca source.
21. The use according to embodiment 20, wherein the modified starch is a physically modified waxy corn starch.
22. The use according to any one of embodiments 16-21, wherein the food product has at least a 25% sugar reduction, at least a 50% sugar reduction, at least a 75% sugar reduction, or a 100% sugar reduction in comparison to a full sugar food product not having the nutritive sweetener replaced by allulose, and wherein the food product has at least a 20% calorie reduction, at least a 30% calorie reduction, at least a 40% calorie reduction, at least a 50% calorie reduction, at least a 60% calorie reduction, at least a 70% calorie reduction, or at least a 80% calorie reduction in comparison to a full sugar food product not having the nutritive sweetener replaced by allulose.
23. The use according to any one of embodiments 17-22, wherein the food product has at least a 5% starch reduction in comparison to a full sugar food product not having the nutritive sweetener replaced by allulose.
24. The use according to any one of embodiments 16-23, wherein the food product is a fruit prep, sweet sauce, confection (e.g. jams and jellies), or dressing.
25. The use according to embodiment 24, wherein the fruit prep is used in a sweetened yogurt (dairy and/or non-dairy).

Subject matter further contemplated by the present disclosure is set out in the following numbered embodiments:

1. A food product composition comprising:
a sugar reduction solution comprising a rare sugar, xylo-oligosaccharide, or a combination thereof;
starch; and
water;
wherein the sugar reduction solution is a partial or complete replacement of a nutritive sweetener; wherein the starch is a granular or modified starch; wherein the food product is stable and does not exhibit syneresis at refrigerated storage over at least 2 weeks as measured by an increase in Hunter L scale measurement of color less than about 5%; and wherein the food product has a sugar, calorie and/or starch reduction in comparison to a full sugar food product not having nutritive sweetener replaced by the sugar reduction solution.
2. The composition of embodiment 1, wherein the sugar reduction solution comprises from about 5 wt-% to about 90 wt-% of the food product composition.
3. The composition of embodiment 1 or 2, wherein the rare sugar is allulose or tagatose.
4. The composition according to embodiment 3, wherein the allulose is a liquid syrup comprising at least about 85% allulose and about 15% other monosaccharides and/or disaccharides, at least about 90% allulose and about 10% other monosaccharides and/or disaccharides, or at least about 95% allulose and about 5% other monosaccharides and/or disaccharides
5. The composition according to any preceding embodiment, wherein the composition has less than about 40 wt-% nutritive sweetener, less than about 35 wt-% nutritive sweetener, less than about 30 wt-% nutritive sweetener, less than about 25 wt-% nutritive sweetener, less than about 20 wt-% nutritive sweetener, less than about 15 wt-% nutritive sweetener, less than about 10 wt-% nutritive sweetener, less than about 5 wt-% nutritive sweetener, or less than about 1 wt-% nutritive sweetener.
6. The composition according to any preceding embodiment, wherein the starch is a chemically or physically-modified starch from a wheat, rice, corn, oat, rye, barley, tapioca, sago, amaranth, arrowroot, sorghum, pea, lentil, banana, potato, sweet potato, and/or tapioca source, and, optionally, wherein the composition comprises at least one additional ingredient.
7. The composition according to any preceding embodiment, wherein the food product has at least a 25% sugar reduction, at least a 50% sugar reduction, at least a 75% sugar reduction, or a 100% sugar reduction in comparison to a full sugar food product not having the nutritive sweetener replaced by the sugar reduction solution, and/or wherein the food product has at least a 20% calorie reduction, at least a 30% calorie reduction, at least a 40% calorie reduction, 50% calorie reduction, at least a 60% calorie reduction, at least a 70% calorie reduction, or at least a 80% calorie reduction in comparison to a full sugar food product not having the nutritive sweetener replaced by the sugar reduction solution, and/or wherein the food product has at least a 5% starch reduction in comparison to a full sugar food product not having the nutritive sweetener replaced by the sugar reduction solution.
8. The composition according to any preceding embodiment, wherein the nutritive sweetener comprises sucrose, glucose, glucose syrup, isoglucose, fructose, glucose-fructose syrup, maltose, lactose, corn syrup, high fructose corn syrup, molasses, honey, agave, or mixtures thereof
9. The composition according to embodiment 8, wherein the nutritive sweetener is sucrose.
10. The composition according to any of embodiments 1-7, wherein the composition does not include sucrose or any nutritive sweetener
11. The composition according to any one of embodiments 1-10, wherein said composition is a fruit prep, sweet sauce, confection (e.g. jams and jellies), or dressing composition.
12. A food product or sweetened dairy/non-dairy yogurt comprising the food product composition according to any of embodiments 1-11.
13. Use of a sugar reduction solution comprising a rare sugar, xylo-oligosaccharide, or a combination thereof to reduce syneresis in a composition comprising: replacing at least a portion of a nutritive sweetener in a food product with a sugar reduction solution comprising a rare sugar, xylo-oligosaccharide, or a combination thereof; and forming a stable food product composition that does not exhibit syneresis under refrigerated storage conditions over at least 2 weeks as measured by an increase in Hunter L scale measurement of color less than about 5%.
14. Use of a sugar reduction solution comprising a rare sugar, xylo-oligosaccharide, or a combination thereof to reduce starch content in a composition comprising: replacing at least a portion of a nutritive sweetener in a food product with a sugar reduction solution comprising a rare sugar, xylo-oligosaccharide, or a combination thereof; and forming a stable food product that does not exhibit syneresis and maintains a higher and stable viscosity thereby reducing the wt-% starch required in the composition.
15. The use according to embodiment 13 or 14, wherein the rare sugar is allulose or tagatose.
16. The use according to any of embodiments 13-15, wherein the sugar reduction solution replaces at least about 25%, at least about 50%, at least about 75%, or 100% of the nutritive sweetener, wherein the nutritive sweetener comprises sucrose.
17. The use according to any one of embodiments 13-16, wherein the starch is a granular starch or a chemically or physically modified starch from a wheat, rice, corn, oat, rye, barley, tapioca, sago, amaranth, arrowroot, sorghum, pea, lentil, banana, potato, sweet potato, or tapioca source, and/or wherein the modified starch is a physically modified waxy corn or tapioca starch.
18. The use according to any one of embodiments 13-17, wherein the food product has at least a 25% sugar reduction, at least a 50% sugar reduction, at least a 75% sugar reduction, or a 100% sugar reduction in comparison to a full sugar food product not having the nutritive sweetener replaced by the sugar reduction solution, and wherein the food product has at least a 20% calorie reduction, at least a 30% calorie reduction, at least a 40% calorie reduction, at least a 50% calorie reduction, at least a 60% calorie reduction, at least a 70% calorie reduction, or at least a 80% calorie reduction in comparison to a full sugar food product not having the nutritive sweetener replaced by the sugar reduction solution, and/or wherein the food product has at least a 5% starch reduction in comparison to a full sugar food product not having the nutritive sweetener replaced by the sugar reduction solution.
19. The use according to any one of embodiments 13-18, wherein the food product composition is a fruit prep, sweet sauce, confection (e.g. jams and jellies), or dressing composition.
20. The use according to embodiment 19, wherein the fruit prep composition is used in a sweetened dairy or non-dairy yogurt.

### EXAMPLES

The embodiments described hereinabove are further defined in the following non-limiting Examples. It should be understood that these Examples, while describing various embodiments of the invention, are given by way of illustration only. From the above discussion and these Examples, one skilled in the art can ascertain the essential characteristics of the invention and, without departing from the spirit and scope thereof, change and modify the embodiments described herein to adapt it to various usages and conditions. Thus, various modifications of the embodiments described herein, in addition to those shown and described herein, will be apparent to those skilled in the art from the foregoing description. Any such modifications are also intended to be encompassed by the claims appended hereto. The features disclosed in the description and Examples set forth herein, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

Vanilla fruit preparation formulations analyzed in the following Examples 1-3 were made according to Table 2. Three formulations with liquid allulose rare sugar were generated at 50%, 70% and 100% sugar reduction (SR) levels (compared to Full Sugar Control). The formulations were adjusted to account for the % solids of the liquid allulose used (a liquid allulose with 95% purity and at 74% solids was used). The control formulation had 50% sucrose, and 5.25% NOVATION PRIMA® 300 physically modified native starch (waxy corn starch). The process conditions and the amount of starch were designed to obtain a good cook quality (i.e. fully swollen starch granules providing the desired viscosity) with the starch. The starch used in the vanilla fruit preparation formulation has very good freeze/thaw stability and tolerance to low temperature storage conditions making it particularly well suited for frozen and refrigerated food products. It also is suitable for high temperature and shear food processing at neutral or low pH conditions.

TABLE 2
Vanilla Fruit Preparation Formulations Containing a
Rare Sugar (Allulose) and Modified Waxy Corn Starch

| | Formula- | Formula- | Formula- | Formula- |
|---|---|---|---|---|
| | tion 1 | tion 2 | tion 3 | tion 4 |
| | Full Sugar | 50% Sugar | 70% Sugar | 100% Sugar |
| Ingredients | (Control) | Reduction | Reduction | Reduction |
| Water | 43.53 | 34.74 | 30.98 | 25.96 |
| Potassium | 0.10 | 0.10 | 0.10 | 0.10 |
| Sorbate | | | | |
| Sucrose | 50.00 | 25.00 | 14.29 | 0 |
| Liquid Allulose | — | 33.78 | 48.26 | 67.57 |
| Physically | 5.25 | 5.25 | 5.25 | 5.25 |
| Modified Starch | | | | |
| Vanilla | 1.10 | 1.10 | 1.10 | 1.10 |
| Extract (2X) | | | | |
| Citric Acid | 0.03 | 0.03 | 0.03 | 0.03 |
| Totals | 100.00 | 100.00 | 100.00 | 100.00 |

| | |
|---|---|
| pH | pH of all samples was ~4.7-4.8 |

### Preparing Vanilla Fruit Preparations

Initially, the vanilla fruit prep formulations were prepared by cooking the water, starch, and half of the sugar, followed by addition of the second half of the sugar. Due to inclusion of Liquid Allulose in the reduced sugar fruit prep formulations, the total amount of water used during starch cooking differed among the full and reduced sugar formulations, affecting the starch cook quality, which in turn affected the viscosity of the fruit preps being prepared. The starch cook quality was standardized by adding an initial amount of water during starch cooking that enabled a “good cook” to be obtained in each of Formulations 1-4 set forth in Table 4, with 25.96% being the minimum amount of water required. As a result, 25.96% water (initial water addition), potassium sorbate and starch were cooked in a THERMOMIX® mixer (Vorwerk International AG, Wuppertal, Germany) that was set to 27 minutes, 185° F., and shear setting of 1. The sugar(s) (including sugar and Liquid Allulose, if present) were combined in a large beaker. The remaining water contained in the formulation was warmed and added to the sugars in the large beaker, which was subsequently gently warmed in a microwave for another 1.5 mins. When the starch was finished cooking, the citric acid was added to the THERMOMIX® mixer, which was set to 4 minutes, with no temperature setting, and at a shear setting of 0.5. The sugar/water mixture was added very slowly to the running THERMOMIX® mixer. The subsequently obtained mixture was poured into a large bowl, the vanilla was added and gently whisked for 30 seconds to create a smooth consistency, and the resulting product was refrigerated.

### Example 1

### Characterization of Fruit Preps Containing the Rare Sugar Allulose Under Refrigerated Storage for Color Change and Syneresis

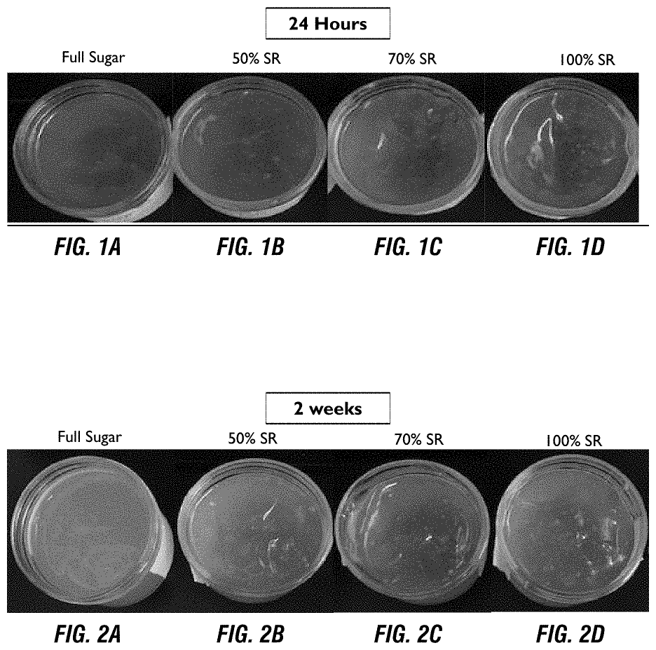

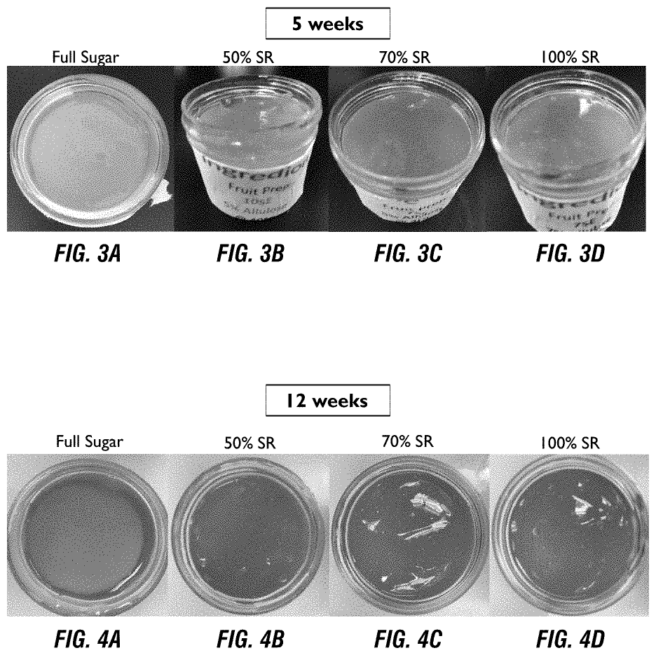

The fruit prep compositions of Table 2 were visually and quantitatively assessed for color changes. Visual observations were recorded and photographs of the fruit prep compositions were taken at 24 hours, 2 weeks, 5 weeks and 12 weeks as shown in FIGS. 1A-1D (24 hours), 2A-2D (2 weeks), 3A-3D (5 weeks), and 4A-4D (12 weeks). As shown in FIGS. 1A-1D, no color differences were observed between Full Sugar and sugar reduced (SR) fruit preps containing Allulose at 24 hours. As shown in FIGS. 2A-2D, at 2 weeks refrigerated storage the Full Sugar fruit prep (FIG. 2A) started to display slightly lighter color (as an indication of syneresis), whereas no change in color was seen in the Allulose containing SR fruit preps (FIGS. 2B-2D). FIG. 3A showed further color change (syneresis) in the Full Sugar fruit prep and water separation at week 5, and FIG. 4A showed even more color change and gelling and more water accumulation (syneresis) at 12 weeks, whereas SR fruit preps with Allulose remained stable at 5 weeks (FIGS. 3B-3D) and 12 weeks (FIGS. 4B-4D).

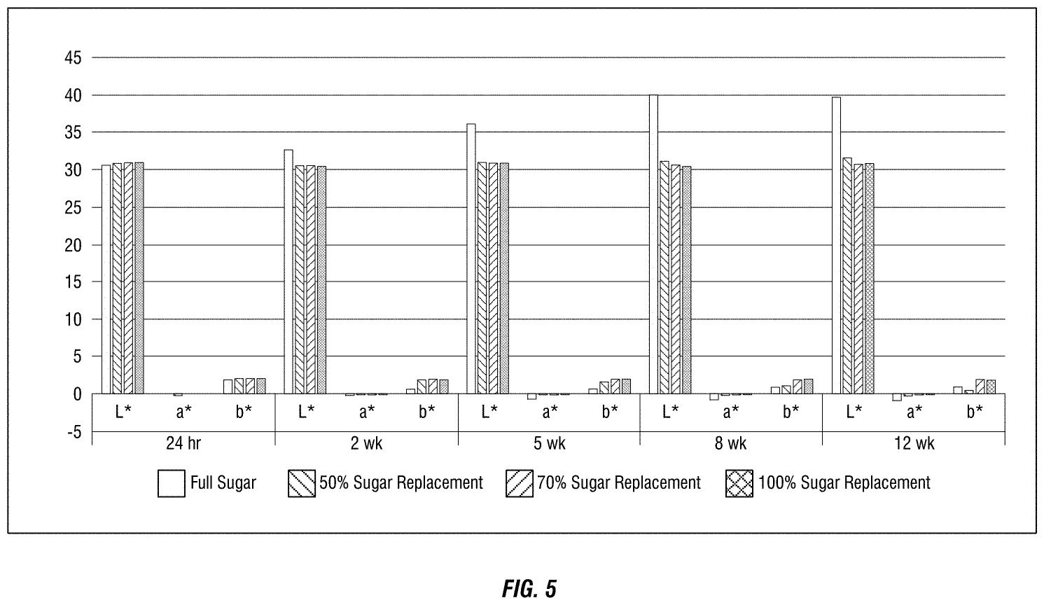

The color changes that were visually observed were confirmed via quantitative L, a, b color measurements (FIG. 5 and Table 3). The quantitative analysis was performed on a ColorQuest XE (Hunter Lab), and analysis was completed after the samples were equilibrated to room temperature. “L” value represents lightness, “a” represents green/red, and “b” represents blue/yellow. At 24 hours, there is no difference seen in the quantitative color of all samples. At 2 weeks, Full Sugar fruit prep L value increased and the b value decreased. This effect continued at 5 weeks due to syneresis. Beneficially, all Allulose containing SR fruit preps remained stable in color over the 12 week period.

As shown in FIG. 5 and Table 3, the L value increased significantly over the 12 week period for the Full Sugar Control, indicating a visual color change and syneresis of the sample. In comparison, the SR fruit preps with Allulose did not exhibit the same L value increase; only the 50% SR fruit prep with Allulose exhibited an L value increase of 3.3% over the 12 week period; no syneresis (L value increase) resulted in the first 2 weeks. Whereas the Full Sugar Control exhibited a 6.5% L value increase over the 2 week period. The 70% and 100% SR fruit preps had no increase in L value over the entire 12 weeks, demonstrating that replacing sugar content with Allulose results in a decrease or elimination of syneresis.

TABLE 3
L, a, b Values of Vanilla Fruit Prep Formulations Containing Allulose and a Modified Waxy Corn Starch

| | | 24 hr | | | 2 wk | | | 5 wk | | | 8 wk | | | 12 wk | | |
|---|---|---|---|---|---|---|---|---|---|---|---|---|---|---|---|---|
| | | L* | a* | b* | L* | a* | b* | L* | a* | b* | L* | a* | b* | L* | a* | b* |
| Full Sugar | | 30.6 | 0 | 1.94 | 32.59 | −0.24 | 0.66 | 36.15 | −0.74 | 0.63 | 39.96 | −0.84 | 0.97 | 39.68 | −0.92 | 0.96 |
| 50% | SR | 30.83 | −0.01 | 2.09 | 30.52 | −0.04 | 1.86 | 30.91 | −0.06 | 1.66 | 31.11 | −0.25 | 1.07 | 31.53 | −0.33 | 0.52 |
| 70% | SR | 30.92 | 0 | 2.08 | 30.48 | −0.02 | 2.02 | 30.84 | −0.06 | 2 | 30.58 | −0.14 | 1.94 | 30.66 | −0.15 | 1.95 |
| 100% | SR | 30.92 | 0.03 | 2.04 | 30.42 | −0.02 | 1.89 | 30.83 | −0.01 | 1.98 | 30.46 | −0.15 | 1.96 | 30.74 | −0.13 | 1.88 |

### Example 2

### Characterization of Fruit Preps Containing the Rare Sugar Allulose Under Refrigerated Storage for Viscosity, Water Activity, and Allulose Content

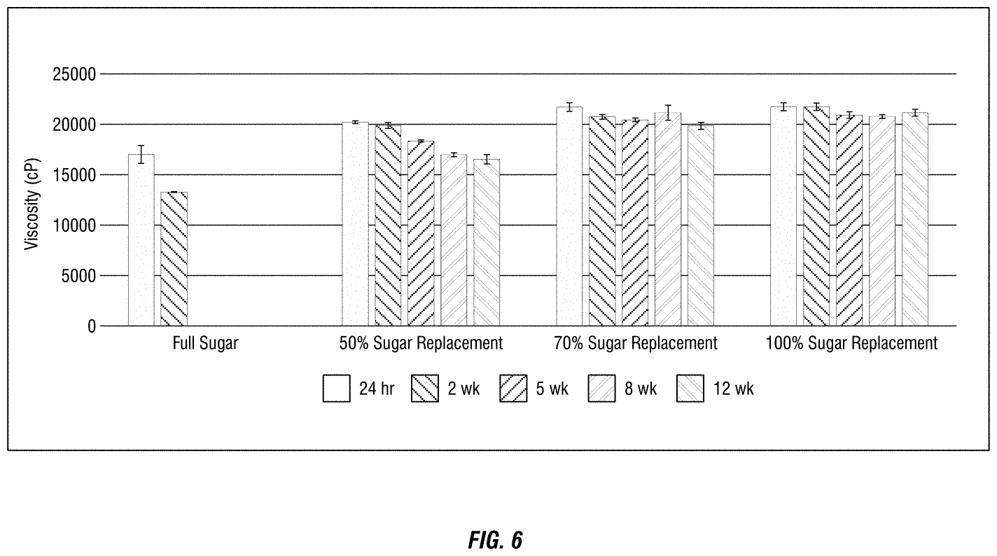

The fruit prep compositions of Table 2 were analyzed for viscosity over time and water activity of the compositions. First. the viscosity of the vanilla fruit preps stored at refrigerated temperature were measured at 24 hours, 2 weeks, 5 weeks, 8 weeks, and 12 weeks. The analysis was performed on a RV Brookfield Viscometer (Brookfield Engineering Laboratories, Inc.) using Spindle T-B, 10 RPM. The data was collected after the samples were equilibrated to room temperature and at 30 sec mark. The viscosity of the Full Sugar and SR fruit preps are shown in FIG. 6 and Table 4.

TABLE 4
Viscosity of Vanilla Fruit Prep Formulations Containing
Allulose and Modified Waxy Corn Starch

| Viscosity (cP) | | Full Sugar | 50% Sugar | 70% Sugar | 100% Sugar |
|---|---|---|---|---|---|
| Measurements | | (Control) | Reduction | Reduction | Reduction |
| 24 | hours | 17013 | 20200 | 21693 | 21733 |
| 2 | weeks | 13280 | 19880 | 20733 | 21733 |
| 5 | weeks | 0 | 18333 | 20440 | 20920 |
| 8 | weeks | 0 | 16973 | 21147 | 20760 |
| 12 | weeks | 0 | 16533 | 19840 | 21147 |

At 24 hours, viscosity of SR fruit preps with Allulose were higher than that of the Full Sugar fruit prep. The Full Sugar fruit prep at week 5 experienced significant syneresis, so viscosity measurements could not be performed beyond week 5. The drop in viscosity between 24 hours and 2 weeks would be due to syneresis development over time in the Full Sugar control sample. Both the 100% and 70% SR fruit preps with Allulose remained stable over 12 weeks of refrigerated storage. 50% SR fruit prep with Allulose demonstrated slight viscosity reduction over time, which also contained significant amount of sugar that would have a tendency to start syneresis similar to the Full Sugar sample, in a lesser amount as confirmed in Example 1 with L value increase.

As a further benefit of the SR fruit prep compositions, at the same starch level, having higher viscosity in Allulose containing samples compared to a Full Sugar control provides an opportunity to formulate with less starch for matching the viscosity of a Full Sugar control. An exemplary fruit prep formulation to match viscosity of a Full Sugar control required only 4.875% of the physically-modified starch (as opposed to 5.25% in Full Sugar Control) to match the viscosity of Full sugar control, demonstrating at least 7% reduction in starch used in the Allulose-containing fruit preps.

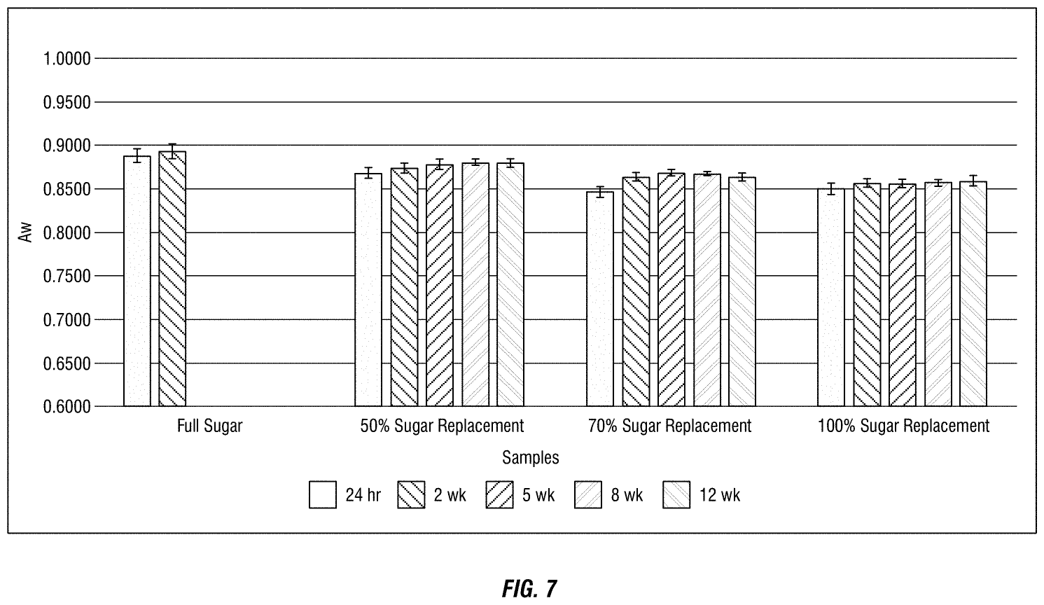

The water activity of the vanilla fruit preps stored at refrigerated temperature were also measured at 24 hours, 2 weeks, 5 weeks, 8 weeks, and 12 weeks. The analysis was performed on a ROTRONIC® Hygrolab water activity indicator (Rotronic Instrument Corp.) after the samples were equilibrated to room temperature. FIG. 7 and Table 5 show the water activity of the fruit prep samples. Allulose containing SR fruit preps had slightly lower water activity compared to the Full Sugar fruit prep, demonstrating an advantage for microbial stability of the compositions as well. Overall, there was no notable change in water activity over the 12 weeks refrigerated storage in samples containing Allulose.

TABLE 5
Water activity of Vanilla Fruit Prep Formulations
Containing Allulose and Modified Waxy Corn Starch

| Water activity | | Full Sugar | 50% Sugar | 70% Sugar | 100% Sugar |
|---|---|---|---|---|---|
| (Aw) | | (Control) | Reduction | Reduction | Reduction |
| 24 | hours | 0.88 | 0.87 | 0.85 | 0.85 |
| 2 | weeks | 0.89 | 0.87 | 0.86 | 0.86 |
| 5 | weeks | 0.00 | 0.88 | 0.87 | 0.86 |
| 8 | weeks | 0.00 | 0.88 | 0.87 | 0.86 |
| 12 | weeks | 0.00 | 0.88 | 0.86 | 0.86 |

The allulose containing samples demonstrate both stable viscosity as well as low water activity compared to Full Sugar compositions, demonstrating better water holding capacity (i.e., no water separation occurs in the allulose containing SR compositions).

Allulose content over storage time (12 weeks) was also monitored as shown in Table 6. The pH of the samples ranged from 4.7-4.8, and no change in allulose content was observed during the duration of the 12 week study, indicating allulose is stable at the pH conditions tested.

TABLE 6
Allulose content in vanilla fruit preps stored over 12 weeks

| | | | Allulose | | | |
|---|---|---|---|---|---|---|
| | | Liquid | Content in | | | |
| | | Allulose in | Sample | | | |
| | | formulation | (calculated) | 2 weeks | 8 weeks | 12 weeks |
| Samples | | (%) | (%) | (%) | (%) | (%) |
| 50% | SR | 33.8 | 23.8 | 23.4 | 24.2 | 23.2 |
| 70% | SR | 48.3 | 33.8 | 33.6 | 33.8 | 33.4 |
| 100% | SR | 67.6 | 47.5 | 46.6 | 47.4 | 46.4 |

### Example 3

### Calorie and Sugar Reduction of Fruit Preps Containing the Rare Sugar Allulose

Table 7 shows the percent calorie and sugar reduction for allulose containing fruit preps. The sugar reduction does not include allulose as added/total sugar content. Beneficially, using allulose at 50-100% sugar reduction levels provides up to 81% calorie reduction in the formulation.

TABLE 7
Percent Calorie & Sugar Reduction in
Vanilla Fruit Preps With Allulose

| | | 50% Sugar | 70% Sugar | 100% Sugar |
|---|---|---|---|---|
| | Full Sugar | Reduction | Reduction | Reduction |
| | (Control) | (target) | (target) | (target) |
| Calories | 210 | 130 | 90 | 40 |
| (kcal/100 g) | | | | |
| Calorie | NA | 38 | 57 | 81 |
| Reduction (%) | | | | |
| Added Sugars | 50 | 26.3 | 16.1 | 2.5 |
| (g/100 g) | | | | |
| Sugar | NA | 48 | 68 | 95 |
| Reduction (%) | | | | |

### Example 4

### Characterization of Fruit Preps Containing the Rare Sugar Allulose as 100% Sugar Replacement and Various Starches Under Refrigerated Storage for Color Change and Syneresis

Examples 1-3 demonstrate that allulose containing samples do not show syneresis under refrigerated storage conditions, whereas the full sugar samples did show significant syneresis within the same time frame. Additional study was undertaken to assess use of various starches to show that unique syneresis benefit of allulose is not limited to a single type of starch. The fruit prep compositions of Table 2 containing the waxy corn starch NOVATION PRIMA® 300 starch were modified to evaluate the additional starches in Table 8 in the vanilla fruit preps in Table 9. Due to the different chemistries and inhibition levels, starch use levels were adjusted (and evaluated from 5% to 6%) to make sure starches were cooked properly. Chemically modified starches were used at 5%, and all NOVATION®-type physically modified starches were used at 5.25%, except NOVATION® 8300 (waxy rice base) starch which required a higher use level of 6%.

TABLE 8
Starch Ingredients Evaluated in Vanilla Fruit
Preparation Formulations Containing Allulose

| | Modification | | Starch | Use |
|---|---|---|---|---|
| Ingredients | Type | Treatment | Base | Level |
| CLEARJEL ® starch | Chemical | STMP/STPP | waxy corn | 5.00 |
| COLFLO ® 67 starch | Chemical | Adipic | waxy corn | 5.00 |
| | | anhydride/ | | |
| | | Acetic acid | | |
| NATIONAL ™ 465 | Chemical | PO/POCl₃ | waxy corn | 5.00 |
| starch | | | | |
| NOVATION ® 2300 | Physical | N/A | waxy corn | 5.25 |
| starch | | | | |
| NOVATION | Physical | N/A | waxy corn | 5.25 |
| PRIMA ® | | | | |
| 300 starch | | | | |
| NOVATION ® 3300 | Physical | N/A | tapioca | 5.25 |
| starch | | | | |
| HOMECRAFT ® | Physical | N/A | waxy | 5.25 |
| CREATE | | | tapioca | |
| 335 starch | | | | |
| NOVATION | Physical | N/A | waxy corn | 5.25 |
| PRIMA ® | | | | |
| 600 starch | | | | |
| NOVATION | Physical | N/A | waxy corn | 5.25 |
| ENDURA ® | | | | |
| 0100 starch | | | | |
| NOVATION ® 8300 | Physical | N/A | waxy rice | 6.00 |
| starch | | | | |

TABLE 9
Vanilla Fruit Preparation Formulations Using Different Starch Use Levels

| | 5.00% Starch | | 5.25% Starch | | 6.00% Starch | |
|---|---|---|---|---|---|---|
| | Full | Allulose | Full | Allulose | Full | Allulose |
| | Sugar | 100% Sugar | Sugar | 100% Sugar | Sugar | 100% Sugar |
| Ingredients | Control | Reduction | Control | Reduction | Control | Reduction |
| Sugar, granulated | 50.00 | 0 | 50.00 | 0 | 50.00 | 0 |
| Water | 44.33 | 26.76 | 44.08 | 26.51 | 43.33 | 25.76 |
| Liquid Allulose | 0 | 67.57 | 0 | 67.57 | 0 | 67.57 |
| Starch | 5.00 | 5.00 | 5.25 | 5.25 | 6.00 | 6.00 |
| Vanilla extract | 0.55 | 0.55 | 0.55 | 0.55 | 0.55 | 0.55 |
| Potassium sorbate | 0.10 | 0.10 | 0.10 | 0.10 | 0.10 | 0.10 |
| Citric acid | 0.03 | 0.03 | 0.03 | 0.03 | 0.03 | 0.03 |
| TOTALS | 100.00 | 100.00 | 100.00 | 100.00 | 100.00 | 100.00 |

The procedure for preparing the vanilla fruit preparations outlined above for Examples 1-3 using the physically modified waxy corn starch was modified. In Examples 1-3 the starch was used at 5.25% and cooked at 185° F. at shear 1.0. Because liquid allulose was used at 50%, 70% and 100% sugar reduction levels, the amount of free water being used was all different in the formulations. As the amount of the available water in the system affects the starch cook quality (especially in the presence of sugar and other ingredients which competes with starch for the available water), in order to standardize the starch cook quality, the starch utilized in Examples 1-3 (NOVATION PRIMA® 300 starch) was cooked in a certain amount of free water first. After starch was fully cooked (to the same degree of cook), all sugar and/or liquid allulose was added and mixed.

As shown in Table 9, the various starches were tested at 100% sugar reduction level with allulose. Because of the different chemistries and modification levels of the starches used, a different standardization for the procedure was required. For instance, chemically modified starches have higher gelatinization temperature, which might result in a less cooked out starch giving rise to syneresis.

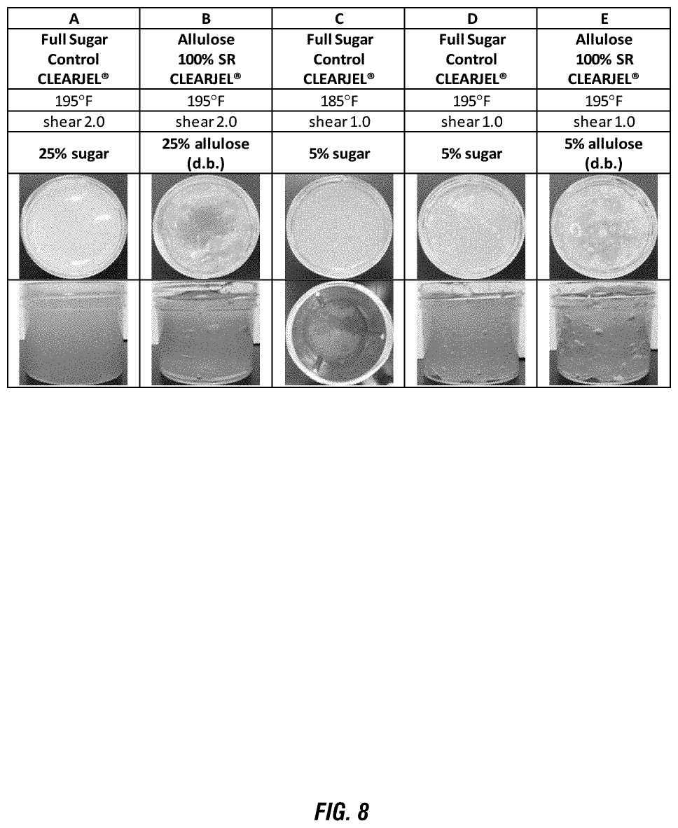

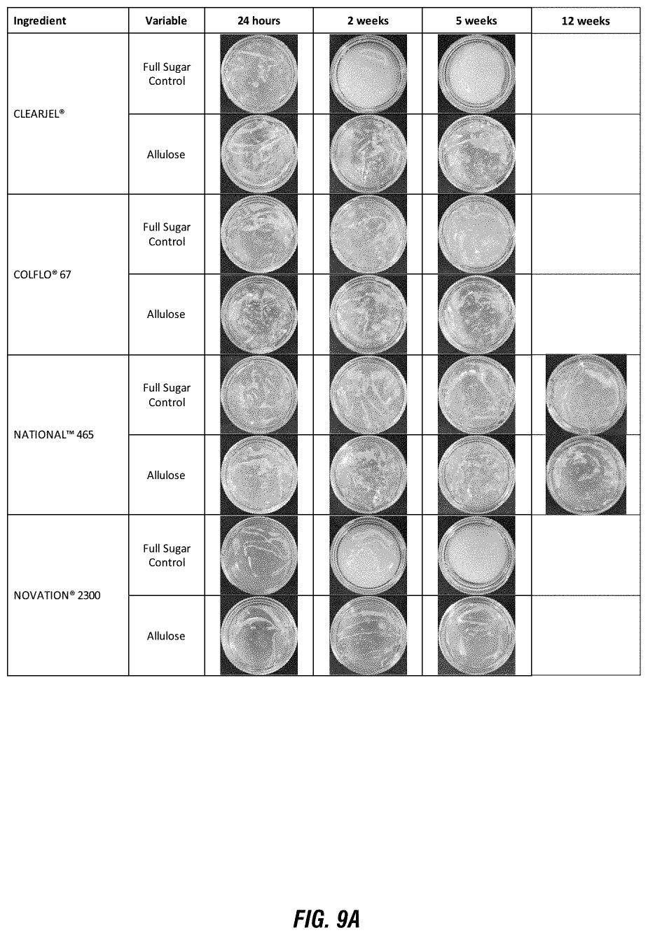

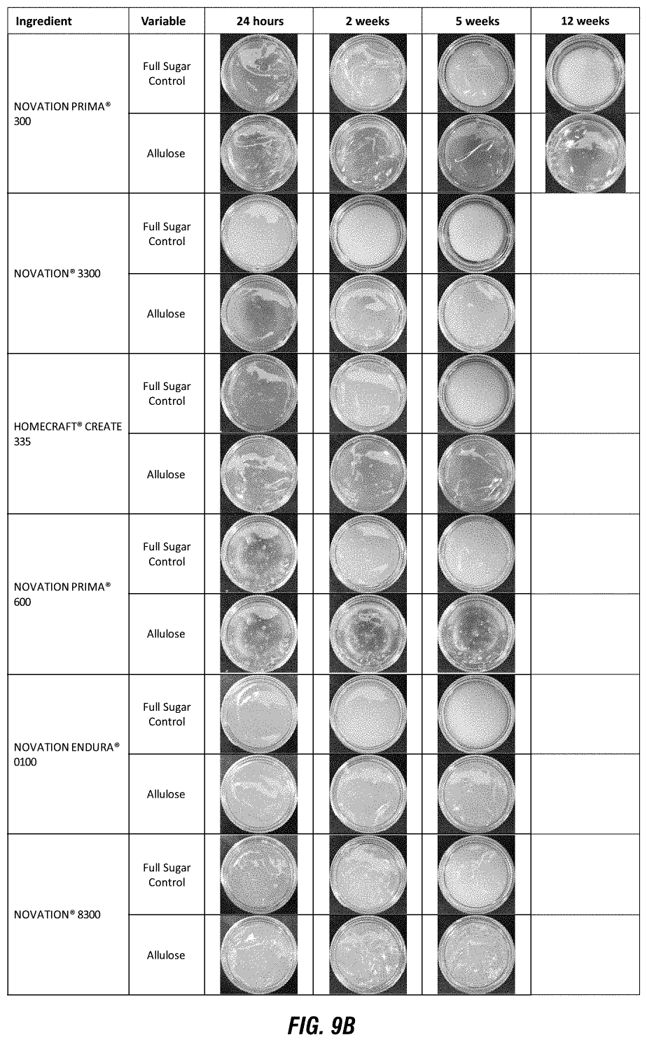

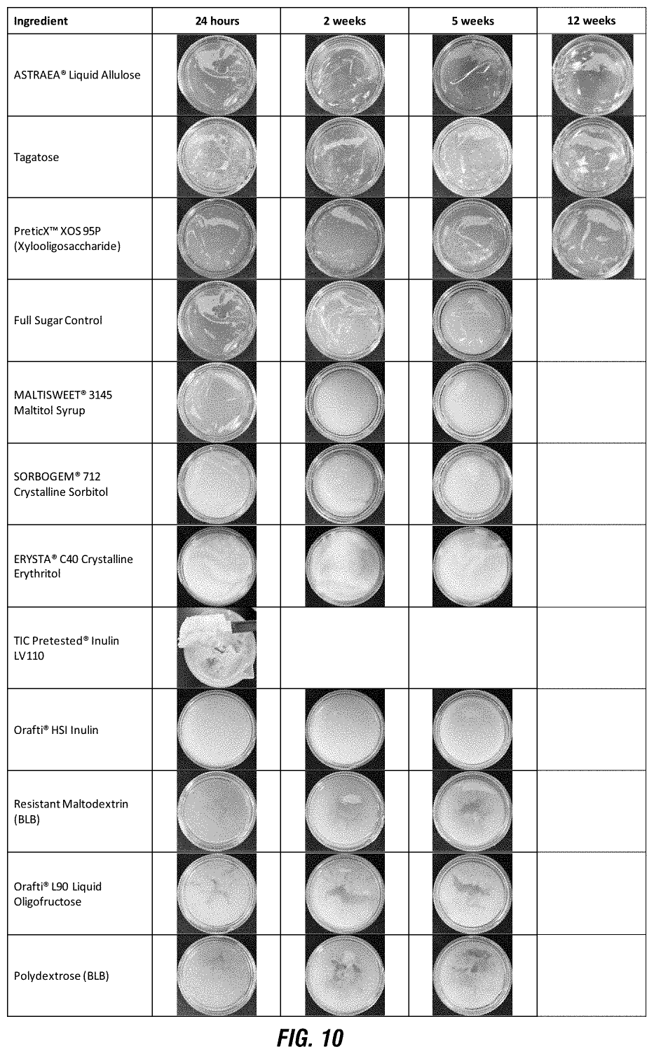

FIG. 7 outlines the various revisions to the preparation method for the Example. One demonstration was done by increasing both temperature (195° F.) and shear (2.0), and cooking the starch in the presence of half of the sugar in the formulation (25%). But the Full Sugar Control with CLEARJEL® starch (which is a chemically-modified starch) would not fully cook out. As seen in the pictures below; if not cooked out well, it was not possible to obtain a clear fruit prep and then from there, syneresis would occur quickly. Since sugar competes for water during starch gelatinization as seen from the 25% sugar presence, for the Example the sugar amount was decreased to 5% during starch cooking. An important observation was that Allulose at 100% sugar reduction level, and with the same cooking conditions as FIG. 8 (Column A), resulted into a well-cooked starch and clear fruit prep FIG. 8 (Column B). This demonstrates that allulose did not compete with starch as much as sugar allowing the starch to successfully gelatinize and cook out forming a successful fruit prep.

Starch cook in presence of 5% sugar (or allulose, d.b.) using the original cooking conditions (185° F., shear 1.0) showed that CLEARJEL® starch would still not completely cook out, and left fish eyes in the Thermomix FIG. 8 (Column C). Increasing the temperature to 195° F., while still keeping shear 1.0, and 5% sugar addition cooked out the starch more fully FIG. 8 (Column D). Evaluating Allulose using the same cooking conditions resulted in a similar starch cook FIG. 8 (Column E). With this procedure, it was provided that even the starches with higher gelatinization temperature, like CLEARJEL® starch, would be able to properly cook. Starting with well cooked, clear fruit preps and observing synthesis/gel formation over storage regardless of starch being used enabled to make a comparison between sugar and allulose's effect on storage stability (syneresis).

Based on these initial evaluations shown in FIG. 8, the modified fruit prep procedure for the variation in starches is listed below and was used for evaluation of both starch and sweetener ingredients in this and the following Example. Modified Fruit Prep Procedure:

1. Weigh the certain amount of initial water, potassium sorbate, and starch in a beaker and transfer to a THERMOMIX® mixer (with mixing blade already in the mixer). This certain amount of water was 28.5% of the whole formulation in case of 5% starch; 28.3% in case of 5.25% starch; 27.5% in case of 6% starch. When using liquid allulose (at 74% solids), there was some amount of water being included through liquid allulose, so the free water amount was adjusted to reflect the total amount of water to be 28.5% which includes free water added to formulation in addition to water content in other components of the formulation, such as allulose, (26.8% water in formulation in Table 9) in case of 5% starch; total amount of water to be 28.3% (26.5% water in formulation in Table 9) in case of 5.25% starch; and total amount of water to be 27.5% (25.8% water in formulation in Table 9) in case of 6% starch. The amount of total water present during starch cook part was standardized by this way to obtain successful starch gelatinization between full sugar and allulose containing samples as the total water impacts starch cook and syneresis.

2. Add 5% sugar (or allulose, d.b.) to the THERMOMIX® mixer for liquid allulose, pre-weigh directly into THERMOMIX® mixer before adding starch slurry in step 1).

3. Set the THERMOMIX® mixer parameters to 27 minutes, 195° F. at a shear setting of 1.0 and start the mixer.

4. Weigh out the vanilla and citric acid, and set aside.

5. Weigh out the remaining amount of sugar (45%) (or allulose, d.b.) into a large beaker and set aside.

6. For full sugar control samples, weigh out the remaining water (full sugar control only) in the formulation into a beaker and set aside. With about 5 minutes remaining, warm the remaining water for 1 minute 30 seconds in the microwave, and add to the beaker with the sugar. Mix with a spatula and gently warm in the microwave for another 1 minute 30 seconds and mix.

7. For samples with allulose, warm the remaining liquid allulose in beaker for 2 minutes in microwave.

8. When the THERMOMIX® mixer cooking is complete, remove lid and tap to allow water to go into the THERMOMIX® mixer.

9. Set the THERMOMIX® mixer to 4 minutes, 195° F. and a shear setting of 1.0.

10. Very slowly add the sugar/water mixture (or liquid allulose) as the Thermomix® mixer is running; add within the first 1 minute.

11. After 4 minutes, add the citric acid and blend by hand in the Thermomix® mixer with a spatula for 60 revolutions.

12. Add vanilla flavor and blend by hand in the THERMOMIX® mixer with a spatula for 60 revolutions.

13. Scoop fruit prep into 2 oz. jars.

14. Refrigerate for future evaluations.

The samples were visually assessed for color changes and syneresis.

Visual observations were recorded and photographs of the fruit prep compositions were taken at 24 hours, 2 weeks, 5 weeks and 12 weeks as shown in FIG. 8 (in columns for 24 hours, 2 weeks, 5 weeks and 12 weeks). As shown in FIG. 8, after 2 weeks, fruit preps prepared with allulose exhibited a syneresis benefit over Full Sugar Controls in all cases except COLFLO® 67 starch and NATIONAL™ 465 starch (meaning Full Sugar Controls exhibited syneresis, and the samples with allulose did not). Full Sugar Controls progressively worsened over time compared to their Allulose counterparts. At the 5 week mark, COLFLO® 67 starch Full Sugar Control started to show syneresis, whereas COLFLO® 67 starch+Allulose sample remained stable. The only starch that has not shown any syneresis in Full Sugar Control after 12 weeks was NATIONAL™ 465 starch, which has a lower gelatinization temperature compared to others evaluated. Allulose fruit preparations did not noticeably change over time, except for NOVATION® 3300 starch after 2 weeks, where some signs of syneresis was observed even in the Allulose samples. Nevertheless, its Full Sugar Control counterpart was still in much worse condition for syneresis (even started at 24 hours), still demonstrating Allulose provides a significant syneresis benefit.

The fruit prep compositions of Table 9 were then analyzed for viscosity over time when stored at refrigerated temperature and measured at 24 hours. The analysis was performed on a RV Brookfield Viscometer (Brookfield Engineering Laboratories, Inc.) using Spindle T-B, 10 RPM. The data was collected after the samples were equilibrated to room temperature and at 30 second mark. The viscosity of the Full Sugar and 100% SR fruit preps are shown in Table 10.

TABLE 10
Viscosity of Vanilla Fruit Prep Formulations
Containing Allulose and Various Starches

| | Viscosity (cP) | |
|---|---|---|
| | Full Sugar | 100% SR |
| Ingredient | Control | Allulose |
| NOVATION PRIMA ® 600 starch | 42,150 | 32,220 |
| NATIONAL ™ 465 starch | 46,400 | 46,550 |
| NOVATION ® 3300 starch | 21,000 | 21,140 |
| COLFLO ® 67 starch | 48,550 | 54,300 |
| CLEARJEL ® starch | 44,000 | 51,000 |
| NOVATION ® 2300 starch | 19,440 | 25,020 |
| NOVATION PRIMA ® 300 starch | 21,300 | 28,060 |
| HOMECRAFT ® CREATE 335 tapioca flour | 18,740 | 26,840 |
| NOVATION ® 8300 starch | 15,060 | 22,760 |
| NOVATION ENDURA ® 0100 starch | 11,960 | 18,340 |

As shown in Table 10, the fruit preps that contained a CLEARJEL®, COLFLO® 67, NOVATION® 2300, NOVATION PRIMA® 300, HOMECRAFT® CREATE 335, NOVATION® ENDURA, or NOVATION® 8300 starch plus Allulose exhibited a higher viscosity over their Full Sugar Control counterparts. Both Full Sugar Control and Allulose containing fruit preps with NATIONAL™ 465 starch exhibited comparable viscosity at 24 hours. This would possibly be due to lower gelatinization temperature of this particular starch (i.e. easier to cook), and therefore not being affected by the presence of either sugar or allulose. In Table 9, both samples were pretty stable even after 5 weeks as well.

The fruit preps with NOVATION® 3300 starch also exhibited comparable viscosity between Full Sugar Control and Allulose counterparts. This starch is a highly inhibited starch, and these 2 samples showed the most difference in their visual observations, and the Full Sugar Control started to exhibit syneresis even at 24 hour mark. Allulose containing sample was also not as stable as the other starch containing counterparts, but nevertheless, relatively it was still more stable than the Full Sugar Control. Only NOVATION PRIMA® 600 starch (which is a lightly inhibited starch) containing Allulose sample exhibited lower viscosity to its Full Sugar Control counterpart, and that would be due to over shearing of this less inhibited starch. Regardless of viscosity, Allulose containing fruit prep was more stable than its Full Sugar Control counterpart.

### Example 5

### Characterization of Fruit Preps Containing Varying Sugar Reduction Solutions and Starches at 100% Sugar Reduction Levels

The fruit prep compositions were evaluated using the various sugar reduction solutions of Table 11. Each of the sugar reduction solutions were evaluated at 100% sugar reduction in the fruit prep formulations with NOVATION PRIMA® 300 starch as the starch.

TABLE 11
Sugar Reduction Solutions Evaluated
in Vanilla Fruit Prep Application

| | Dry | Use |
|---|---|---|
| Ingredient | Solids (%) | Level (%) |
| ASTRAEA ® Liquid Allulose | 74.0 | 67.6 |
| Tagatose | 95.0 | 50.0 |
| MALTISWEET ® 3145 Maltitol Syrup | 75.1 | 66.6 |
| SORBOGEM ® 712 Crystalline Sorbitol | 98.5 | 50.0 |
| ERYSTA ® C40 Crystalline Erythritol | 99.8 | 50.0 |
| TIC PRETESTED ® Inulin LV110 | 96.0 | 50.0 |
| ORAFTI ® HSI Inulin | 95.0 | 50.0 |
| ORAFTI ® L90 Liquid oligofructose | 75.3 | 66.4 |
| Polydextrose | 97.0 | 50.0 |
| PreticX ™ 95P XOS | 97.7 | 50.0 |
| Resistant Maltodextrin | 95.0 | 50.0 |

Table 12 shows the 100% sugar reduced vanilla fruit prep formulations using a dry sweetener or fiber (e.g. tagatose, xylooligosaccharide (XOS)), liquid allulose, maltitol syrup, and liquid oligofructose (ORAFTI® L90 oligofructose, Beneo GMBH, Mannhein, Germany). In all of the samples, the amount of water was standardized, and the cooking procedure was standardized as described in Example 4.

TABLE 12
100% Sugar Reduced Vanilla Fruit Prep Formulations

| | Dry Bulking | Liquid | Maltitol | Liquid |
|---|---|---|---|---|
| | Agent | Allulose | Syrup | Oligofructose |
| | 100% Sugar | 100% Sugar | 100% Sugar | 100% Sugar |
| Ingredients | Reduction | Reduction | Reduction | Reduction |
| Bulking agent, dry | 50.00 | 0 | 0 | 0 |
| Water | 44.08 | 26.51 | 27.50 | 27.67 |
| ASTRAEA ® Liquid | 0 | 67.57 | 0 | 0 |
| Allulose | | | | |
| MALTISWEET ® | 0 | 0 | 66.58 | 0 |
| 3145 Maltitol Syrup | | | | |
| ORAFTI ® L90 | 0 | 0 | 0 | 66.40 |
| Liquid Oligofructose | | | | |
| NOVATION | 5.25 | 5.25 | 5.25 | 5.25 |
| PRIMA ® 300 starch | | | | |
| Vanilla extract | 0.55 | 0.55 | 0.55 | 0.55 |
| Potassium sorbate | 0.10 | 0.10 | 0.10 | 0.10 |
| Citric acid | 0.03 | 0.03 | 0.03 | 0.03 |
| TOTALS | 100.00 | 100.00 | 100.00 | 100.00 |

As described in Example 4, only 5% sugar or sweetener/fiber (on dry basis) in the formulation was added upfront to control starch gelatinization. The initial water amount (used during starch cooking) was standardized at 28.3% in the formulation. Depending on whether the sweetener/fiber was a liquid or powder form, the free water amount was adjusted to reflect the total amount of water to be 28.3%.

Visual observations of the syneresis for the fruit preps prepared with the various sugar reduction solutions is shown in FIG. 10. Only the rare sugar tagatose and XOS (xylooligosaccharide) exhibited comparable stability to the rare sugar allulose after 12 weeks refrigerated storage over Full Sugar Control. One additional observation was; even the fruit prep prepared with Tagatose did not show any syneresis after 12 weeks refrigerated storage, it started to show some crystallization. All other samples either showed significant syneresis (such as maltitol syrup, crystalline sorbitol) being similar or worse than Full Sugar Control, or preparing a successful 100% sugar reduced fruit prep was not possible due to the properties of the sweetener/fiber (crystalline erythritol not highly soluble and crystallized; LV110 inulin could not be processed; ORAFTI® HSI inulin gelled (Beneo GMBH, Mannhein, Germany); ORAFTI® L90 gelled oligofructose and syneresis obvious over time; Polydextrose and Resistant Maltodextrin not successful fruit preps at this sugar reduction level).

The fruit prep compositions of Table 12 were then analyzed for viscosity over time when stored at refrigerated temperature and measured at 24 hours. The analysis was performed on a RV Brookfield Viscometer (Brookfield Engineering Laboratories, Inc.) using Spindle T-B, 10 RPM. The data was collected after the samples were equilibrated to room temperature and at 30 second mark. The viscosity of the fruit preps are shown in Table 13.

TABLE 13
Viscosity Results for Successful Vanilla Fruit Preps
Prepared with Various Sweeteners and Fibers

| | Viscosity |
|---|---|
| Ingredient | (cP) |
| ASTRAEA ® Liquid Allulose | 28,060 |
| Tagatose | 29,000 |
| PreticX ™ 95P XOS (SIDP, Inc., City of Industry, CA) | 22,760 |
| Full Sugar Control | 21,300 |
| MALTISWEET ® 3145 | 13,860 |

As shown in Table 13, the use of the rare sugars allulose and tagatose and XOS increased the viscosity of the fruit prep composition compared to a full sugar control. This can provide a further benefit of the SR fruit prep compositions, which at the same starch level, having higher viscosity compared to a Full Sugar control provides an opportunity to formulate with less starch for matching the viscosity of a Full Sugar control.

1. A food product composition comprising:
a sugar reduction solution comprising a rare sugar, xylo-oligosaccharide, or a combination thereof;
starch; and
water;
wherein the sugar reduction solution is a partial or complete replacement of a nutritive sweetener; wherein the starch is a granular or modified starch; wherein the food product is stable and does not exhibit syneresis at refrigerated storage over at least 2 weeks as measured by an increase in Hunter L scale measurement of color less than about 5%; and wherein the food product has a sugar, calorie and/or starch reduction in comparison to a full sugar food product not having nutritive sweetener replaced by the sugar reduction solution.

2. The composition of claim 1, wherein the sugar reduction solution comprises from about 5 wt-% to about 90 wt-% of the food product composition.

3. The composition of claim 1, wherein the rare sugar is allulose or tagatose.

4. The composition according to claim 3, wherein the allulose is a liquid syrup comprising at least about 85% allulose and about 15% other monosaccharides and/or disaccharides, at least about 90% allulose and about 10% other monosaccharides and/or disaccharides, or at least about 95% allulose and about 5% other monosaccharides and/or disaccharides

5. The composition according to claim 1, wherein the composition has less than about 40 wt-% nutritive sweetener, less than about 35 wt-% nutritive sweetener, less than about 30 wt-% nutritive sweetener, less than about 25 wt-% nutritive sweetener, less than about 20 wt-% nutritive sweetener, less than about 15 wt-% nutritive sweetener, less than about 10 wt-% nutritive sweetener, less than about 5 wt-% nutritive sweetener, or less than about 1 wt-% nutritive sweetener.

6. The composition according to claim 1, wherein the starch is a chemically or physically-modified starch from a wheat, rice, corn, oat, rye, barley, tapioca, sago, amaranth, arrowroot, sorghum, pea, lentil, banana, potato, sweet potato, and/or tapioca source, and, optionally, wherein the composition comprises at least one additional ingredient.

7. The composition according to claim 1, wherein the food product has at least a 25% sugar reduction, at least a 50% sugar reduction, at least a 75% sugar reduction, or a 100% sugar reduction in comparison to a full sugar food product not having the nutritive sweetener replaced by the sugar reduction solution, and/or wherein the food product has at least a 20% calorie reduction, at least a 30% calorie reduction, at least a 40% calorie reduction, 50% calorie reduction, at least a 60% calorie reduction, at least a 70% calorie reduction, or at least a 80% calorie reduction in comparison to a full sugar food product not having the nutritive sweetener replaced by the sugar reduction solution, and/or wherein the food product has at least a 5% starch reduction in comparison to a full sugar food product not having the nutritive sweetener replaced by the sugar reduction solution.

8. The composition according to claim 1, wherein the nutritive sweetener comprises sucrose, glucose, glucose syrup, isoglucose, fructose, glucose-fructose syrup, maltose, lactose, corn syrup, high fructose corn syrup, molasses, honey, agave, or mixtures thereof, or the nutritive sweetener is sucrose or the composition does not include sucrose or any nutritive sweetener.

9. (canceled)

10. (canceled)

11. The composition according to claim 1, wherein said composition is a fruit prep, sweet sauce, confection (e.g. jams and jellies), or dressing composition.

12. A food product or sweetened dairy/non-dairy yogurt comprising the food product composition according to claim 1.

13. A method of using Use of a sugar reduction solution comprising a rare sugar, xylo-oligosaccharide, or a combination thereof to reduce syneresis in a composition comprising: replacing at least a portion of a nutritive sweetener in a food product with a sugar reduction solution comprising a rare sugar, xylo-oligosaccharide, or a combination thereof; and forming a stable food product composition that (i) does not exhibit syneresis under refrigerated storage conditions over at least 2 weeks as measured by an increase in Hunter L scale measurement of color less than about 5%, or (ii) does not exhibit syneresis and maintains a higher and stable viscosity thereby reducing the wt-% starch required in the composition.

14. (canceled)

15. The method according to claim 13, wherein the rare sugar is allulose or tagatose.

16. The method according to claim 13, wherein the sugar reduction solution replaces at least about 25%, at least about 50%, at least about 75%, or 100% of the nutritive sweetener, wherein the nutritive sweetener comprises sucrose.

17. The method according to claim 13, wherein the starch is a granular starch or a chemically or physically modified starch from a wheat, rice, corn, oat, rye, barley, tapioca, sago, amaranth, arrowroot, sorghum, pea, lentil, banana, potato, sweet potato, or tapioca source, and/or wherein the modified starch is a physically modified waxy corn or tapioca starch.

18. The method according to claim 13, wherein the food product has at least a 25% sugar reduction, at least a 50% sugar reduction, at least a 75% sugar reduction, or a 100% sugar reduction in comparison to a full sugar food product not having the nutritive sweetener replaced by the sugar reduction solution, and wherein the food product has at least a 20% calorie reduction, at least a 30% calorie reduction, at least a 40% calorie reduction, at least a 50% calorie reduction, at least a 60% calorie reduction, at least a 70% calorie reduction, or at least a 80% calorie reduction in comparison to a full sugar food product not having the nutritive sweetener replaced by the sugar reduction solution, and/or wherein the food product has at least a 5% starch reduction in comparison to a full sugar food product not having the nutritive sweetener replaced by the sugar reduction solution.

19. The method according to claim 13, wherein the food product composition is a fruit prep, sweet sauce, confection (e.g. jams and jellies), or dressing composition.

20. The method according to claim 19, wherein the fruit prep composition is added a sweetened dairy or non-dairy yogurt.
